(19) United States
(12) Patent Application Publication
(10) Pub. No.: US 2018/0248868 A1
(43) Pub. Date: Aug. 30, 2018

(54) METHOD AND COMMUNICATION SYSTEM FOR SECURED AND AUTOMATED COMMUNICATION

(71) Applicant: DEUTSCHE TELEKOM AG, Boon (DE)

(72) Inventors: Jörg BREUER, Kreuztal (DE); Rainer MOOS, Siegen (DE)

(21) Appl. No.: 15/752,842

(22) PCT Filed: Aug. 11, 2016
(86) PCT No.: PCT/EP2016/069169

§ 371 Date: Feb. 14, 2018

(30) Foreign Application Priority Data
Aug. 14, 2015 (DE) 10 2015 113 443.8
Aug. 14, 2015 (EP) 15181116.3

(51) Int. Cl. H04L 29/06; H04W 12/06; G06F 21/57

(52) U.S. Cl. CPC H04L 63/0853; H04L 63/0876; H04W 88/02; G06F 21/572; G06F 2221/034; H04W 12/06

(57) ABSTRACT

A method and a communication system for secured and automated communication between a data management device and a hardware security device of a communication device, which make it possible to exchange information in an authentic, integrity-secured, confidential, and automated manner even with the hardware security device of a communication device that is not always permanently accessible, in order, for example, to support necessary security updates, administration activities, or other life-cycle processes for the hardware security device.

### FIELD

The invention relates to a method and to a communication system for secured and automated communication between a data management device and a communication device via at least one communication network.

### BACKGROUND

Today, people mostly communicate by phone, mobile communication, or by the Internet via email, Facebook, Twitter, or other ways.

What is needed to provide for such a communication, is access to a telephone network, mobile communication network, or the Internet, for example. Connection to the Internet is accomplished via Internet providers which can be reached via various networks. For the communication per se, smartphones, tablet computers, wearables, or PCs are used in a myriad of forms.

In the future, however, not only people will communicate, but also machines or devices will increasingly be actively involved in communication. In order to allow to exchange information between all those involved in a meaningful and authentical way, it is necessary in the age of Industry 4.0 or the Internet of Things that more and more of such components are given an electronic identity. Reasonably, the introduction of such electronic identities takes place in the form of so-called security tokens which are cryptographically secured and make their respective identity unique. With an increasing number of such components, the number of attacks and hence the security requirements will increase as well. Therefore, the security tokens of such components must be kept up to date, in particular in order to be able to continuously ensure reliability of the security mechanisms.

In the future, it will become more and more important to selectively communicate with components that include a security token, for example in order to support security updates or other life-cycle processes for the security tokens. However, the updating of communication devices that include a hardware security device becomes more and more complex and costly as their number increases.

### SUMMARY

The invention is therefore based on the object to provide a method and a communication system which allow for communication between a data management device and a communication device that includes a hardware security device in a cost-effective and simple manner, even if the communication device is not permanently accessible.

What can be considered as a key idea of the invention is to communicate in a secured and automated manner even with communication devices that are not always permanently accessible, for example in order to support necessary security updates, administration activities, or other life-cycle processes for the hardware security device.

Another aspect of the invention can be considered to be capable in this case of communicating in both directions between the data management device and the hardware security device of the communication device. In other words, it may be intended that the hardware security device of a communication device is capable of, for example, receiving security updates, but also of transmitting itself information to the data management device, for example about its own security status or about attacks on the communication device.

In order to prevent this information from being altered or intercepted, it has to be possible to transfer this information over the entire communication path in a secured manner, i.e. authentically, integrity-secured, and confidentially.

The technical problem stated above is solved, on the one hand, by the method steps of claim 1.

Accordingly, a method is provided for secured and automated communication between a data management device and a communication device of a communication system which comprises at least one communication network. The method comprises the steps of:

a) initiating, by the communication device, in response to a predetermined event, an establishment of a communication connection between a data management device and a hardware security device disposed in a communication device via at least one communication network for a time interval of limited length, wherein the data management device and the communication device are uniquely associated with each other such that information can only be transferred from the hardware security device to the data management device and vice versa, and wherein the hardware security device is configured for identifying the communication device;

b) identifying the communication device to the data management device;

c) checking, in the data management device, whether there is a communication task waiting concerning the communication device;

d) if so, and after successful identification, executing the communication task under control of the data management device, by transferring data in secured manner via the communication connection established in step a).

It should be noted that the term “secured communication” is preferably to be understood as meaning that information is transferred in an authentical, integrity-assured, and confidential manner over the entire communication path between the data management device and the communication device. One technology that makes this possible is, for example, IP Security Technology in conjunction with Message Authentication Code Technology, also referred to as MAC, for short.

The communication device that includes a hardware security device may, for example, be a mobile contact-based and/or contact-free communication device such as a smart card, a mobile wireless communication device such as a smartphone, or a stationary wireless and/or contact-based communication device.

The method step of “establishing a communication connection between a data management device and a communication device for a time interval of limited length” also covers the case that, for example, the contact between the data management device and a hardware security device included in the communication device breaks down very fast, i.e. already after a few seconds or less, for whatever reason.

The term “communication task” in particular identifies information that is available for the communication device, i.e. for the hardware security device of the communication device. A communication task may as well relate to information that is to be transmitted from the hardware security device of the communication device to the data management device.

Preferably, a communication task relates to security updates for a software stored in the hardware security device of the communication device, to upgrades, patches, blocking or disabling commands, for example in order to be able to remotely block or disable the communication device or the hardware security device, or relates to other information that is available in the data management device and is intended for the communication device or its hardware security device.

Furthermore, as already mentioned, a communication task may also relate to information which is to be transmitted from the hardware security device of the communication device to the data management device. Such information may, for example, include status information or information about the current location of the communication device. The information may also include trusted messages, short messages, e-mails, control information, and/or the like.

For the case that the communication connection established in step a) breaks down before the entire communication task has been executed, that is, before all the information associated with the communication task has been transmitted to the communication device or to the hardware security device, it is possible to check in the data management device, whether the communication task has been completely executed during the communication connection established in step a). If not, steps a), b), d), and e) are repeated until the communication task has been completely executed, that is to say until in particular the information associated with the communication task has been completely received by the hardware security device of the communication device. Step d) then comprises, after successful identification, the execution of the communication task under control of the data management device by transferring data in a secured manner via the communication connection established in step a). Preferably, only those data of the associated communication task are transferred, which have not yet been transferred.

The technical problem stated above is also solved by the method steps of claim 3.

Accordingly, a method is provided for secured and automated communication between a data management device and a communication device of a communication system which comprises at least one communication network.

The method comprises the following steps:

a) initiating, by the communication device, in response to a predetermined event, an establishment of a communication connection between a central management device and the hardware security device implemented in the communication device via the at least one communication network, wherein the hardware security device is configured to identify the communication device;

b) identifying the communication device to the central management device;

c) after successful identification, establishing, under control of the central management device, a communication connection between a data management device and the hardware security device of the communication device via the at least one communication network for a time interval of limited length, wherein the data management device and the communication device are uniquely associated with each other such that information can only be transferred from the hardware security device to the data management device and vice versa;

d) checking, in the data management device, whether there is a communication task waiting concerning the communication device;

e) if so, executing the communication task under control of the data management device by transferring data in secured manner via the communication connection established in step c).

It should be noted at this point that a unique association between a data management device and a communication device means that data can only be transferred from the data management device to the hardware security device of the communication device, which is uniquely associated with the data management device, and vice versa.

In order to ensure that a communication task has been completely executed by the data management device, the data management device preferably checks, in a step f), whether the communication task has been completely executed during the secure communication connection established in step c). If not, steps a) to c), e), and f) of claim 3 are repeated, according to a step g), until the communication task has been completely executed. Step e) then comprises, after successful identification, the execution of the communication task under control of the data management device by transferring data in secured manner via the communication connection established in step c). Preferably, only those data of the associated communication task are transferred, which have not yet been transferred.

According to one exemplary embodiment, the data management device communicates directly with the hardware security device of the communication device.

According to an alternative exemplary embodiment, the communication device is a wireless communication device which is indirectly connected to the data management device by the fact that in step a) of claim 1 a communication connection can be established via a wireless access point of the communication system as soon as the wireless communication device enters the coverage area of the wireless access point, or the communication device is a contact-based communication device which is indirectly connected to the data management device by the fact that in step a) a communication connection can be established via a contact-based device of the communication system as soon as the contact-based communication device has been electrically connected to the contact-based device. The contact-based device may be configured as a card reader which can be connected to the at least one communication network. The wireless access point may preferably be a WLAN access point.

An indirect connection is also existent if the communication device is a mobile contact-based communication device which is for instance inserted in a contact-based card reading device, while the card reading device is connected to the data management device via at least one communication network.

If the communication device is a wireless communication device, a respective communication connection can similarly be established in steps a) and c) of claim 3 via a wireless access point of the communication system as soon as the wireless communication device enters the coverage area of the wireless access point. Or, if the communication device is a contact-based communication device, a respective communication connection can be established in steps a) and c) via a contact-based device of the communication system as soon as the contact-based communication device has been electrically connected to the contact-based device.

Preferably, the wireless communication device is a mobile communication device and the wireless access point is stationary.

Alternatively, it is also possible that the wireless communication device is stationary and the wireless access point is mobile.

A mobile wireless communication device may, for example, be a smartphone, a tablet computer, wearables, and the like. A mobile wireless access point may, for example, be a public WLAN access point, also referred to as a hotspot, which is implemented in a vehicle, for example. A stationary wireless communication device may, for example, be a sensor that is integrated near the street, for example in a lamp or a traffic light.

In order to be able to signal to the data management device that a communication task has been completely executed, the communication device or the hardware security device of the communication device can transmit a status information to the data management device, which signals that the communication task has been executed completely, for example that the information associated with a communication task has been completely received, or that the information has been completely processed in the communication device.

The communication device may also transmit further status information to the data management device signaling the data management device that the information associated with the communication task has not yet been received completely. Particularly advantageously, the status information moreover signals the data management device at which point the execution of the communication task has been aborted or at which point the transfer of information has broken down, in order to provide for seamless execution of the communication task or seamless and therefore complete transfer of the information.

In order to achieve the highest possible degree of confidentiality, the information to be transmitted to the communication device is preferably stored in encrypted form in the data management device. This means that even in the data management device the information intended for the hardware security device of the communication device is never available in plain text and consequently cannot be intercepted.

As already mentioned, the information to be transferred to the communication device or to the hardware security device of the communication device may contain security-related data, in particular security updates for a security software stored in the communication device or the hardware security device.

If, for example, there are different communication tasks waiting in the data management device, wherein at least one of the communication tasks may relate to the transfer of information from the communication device to the data management device, the execution of the different communication tasks is prioritized by the data management device. In other words, the execution of the different communication tasks is accomplished in a predetermined order, the communication tasks being prioritized according to their importance.

According to a favorable embodiment it is contemplated that a communication connection established in step a) according to claim 1 or in step c) according to claim 3 can be terminated by the data management device if there is no communication task waiting in the data management device, that is if neither information is to be transmitted from the hardware security device of the communication device to the data management device nor information is to be transmitted from the data management device to the hardware security device.

The technical problem stated above is also solved by the features of claim 14.

Accordingly, a communication system for secured and automated communication between a data management device and a communication device is provided, comprising the following features:
at least one communication network,
a communication device including a hardware security device for identifying the communication device,
a data management device uniquely associated with the communication device such that information can only be transferred from the hardware security device to the data management device and vice versa, wherein the data management device includes a memory device which can store at least one piece of information for the hardware security device of the communication device;
   wherein the communication device is configured to be responsive to a predetermined repetitive event to initiate, in each case, the establishment of a temporarily limited communication connection via the at least one communication network from the hardware security device to the data management device, and to identify to the data management device;
   wherein the data management device is configured
to check whether there is a communication task waiting concerning the communication device,
if so, and after successful identification of the communication device, to control the execution of the communication task by transferring data in secured manner via the respective established communication connection.

The technical problem stated above is also solved by the features of claim 15.

Accordingly, a communication system for secured and automated communication between a data management device and a communication device is provided, comprising the following features:
at least one communication network,
a central management device,
a communication device including a hardware security device for identifying the communication device,
a data management device uniquely associated with the communication device such that information can only be transferred from the hardware security device to the data management device and vice versa, wherein the data management device includes a memory device which can store at least one piece of information for the hardware security device of the communication device,
   wherein the communication device is configured to be responsive to a predetermined repetitive event to initiate, in each case, the establishment of a communication connection via the at least one communication network from the hardware security device to the central management device, and to identify toward the central management device,
   wherein the central management device is configured, after each successful identification of the communication device, to control the establishment of a temporarily limited communication connection between the hardware security device of the communication device and the data management device via the at least one communication network; wherein the data management device is configured
to check whether there is a communication task waiting concerning the communication device,
if so, to control the execution of the communication task by transferring data in secured manner via the respective established communication connection.

Preferably, the data management device is configured to check whether the communication task has been completely executed during an established secure communication connection, and if not, to continue to execute the communication task during at least one further communication connection established between the communication device and the data management device.

According to a particular embodiment, at least one wireless access point is provided which is connected to the at least one communication network, and the communication device is a wireless communication device and is configured to detect an entry into the coverage area of the at least one wireless access point and in response thereto to initiate the establishment of a communication connection via the wireless access point to the data management device or to the central management device.

For example, at least one contact-based device may be provided, such as a card reading device, which is connected to the at least one communication network, and the communication device is a contact-based communication device and is configured to detect an electrical connection or contact to the at least one contact-based device and, in response thereto, to initiate the establishment of a communication connection via the contact-based device to the data management device uniquely associated therewith, or to the central management device.

It should be noted at this point that the claims also cover the case in which a plurality of data management devices are provided, as well as a plurality of communication devices each one including a hardware security device, and where a respective communication connection can be established between each data management device and the communication device uniquely associated therewith. However, data can only be exchanged between a respective one of the data management devices and the hardware security device of the communication device which is uniquely associated with the data management device.

The hardware security device which may also be referred to as a security token, may be a chip card, a SIM card, or any hardware security module representing a Trusted Execution Environment (TEE).

### BRIEF DESCRIPTION OF THE DRAWINGS

The invention will now be explained in more detail with reference to several exemplary embodiments in conjunction with the accompanying drawings in which the same reference numerals refer to the same devices, and wherein:

FIG. 1 shows an exemplary communication system with an indirect connection between two wireless communication devices and two data management devices;

FIG. 2 shows an alternative exemplary communication system comprising a central management device, wherein each wireless communication device is connected to the uniquely associated data management device via a respective indirect connection, like in FIG. 1;

FIG. 3 shows another exemplary communication system in which wireless communication devices are directly connected to data management devices;

FIG. 4 is an exemplary block diagram of the mobile wireless communication device shown in FIGS. 1 and 2;

FIG. 5 is an exemplary block diagram of the data management device shown in FIG. 1;

FIG. 6 is an exemplary block diagram of a stationary wireless communication device shown in FIGS. 1 and 2; and

FIG. 7 shows an exemplary communication system with an indirect connection between a wireless communication device and a data management device and also between a contact-based communication device and a data management device.

### DETAILED DESCRIPTION

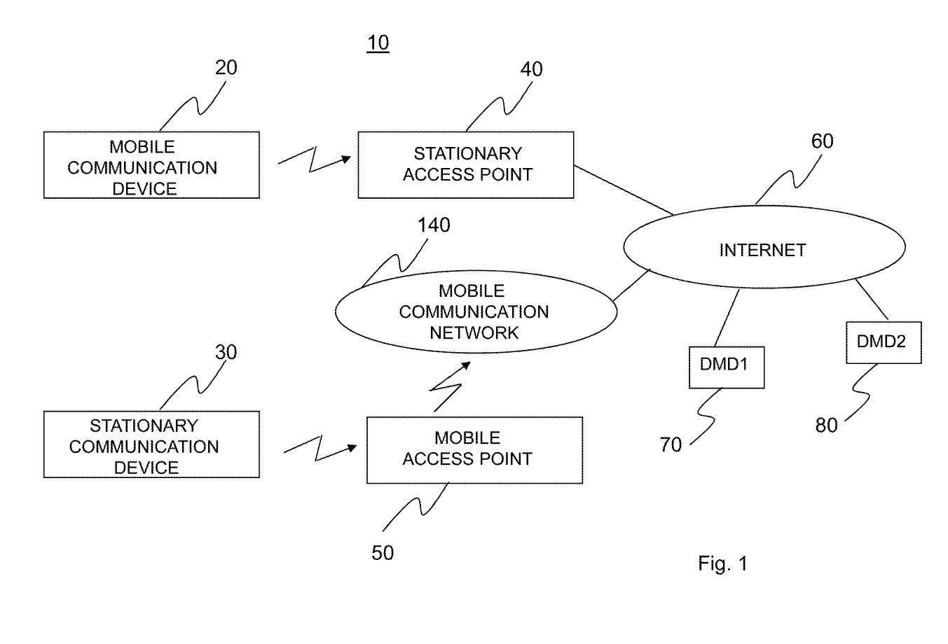

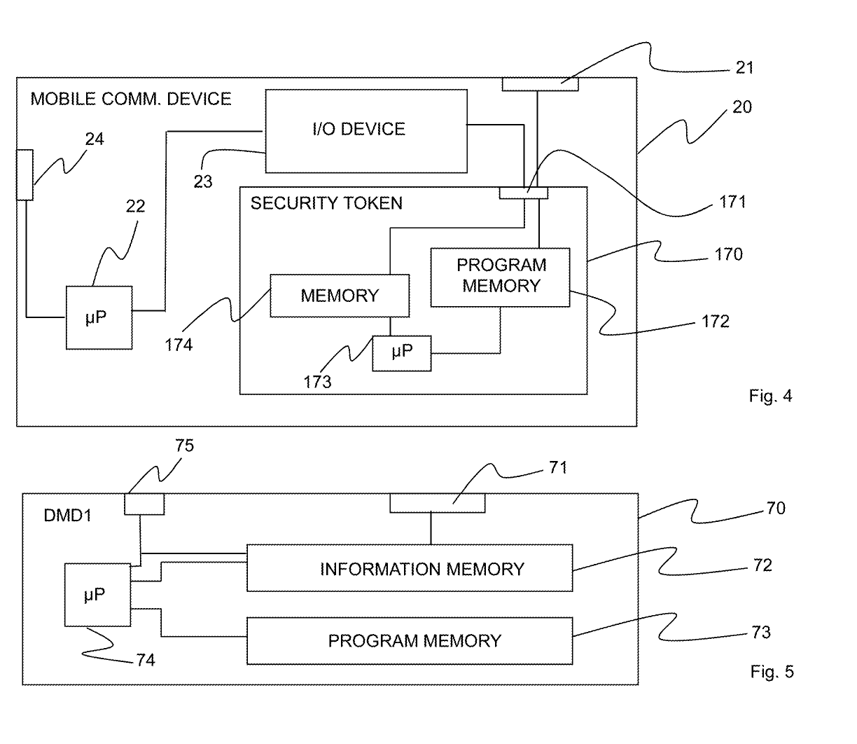

FIG. 1 shows part of an exemplary communication system 10 for secured and automated communication between a data management device and a hardware security device of a wireless communication device. Communication system 10 comprises at least one communication network. In the present example, two communication networks 60 and 140 are shown, wherein the one communication network 60 is the Internet, and the other communication network 140 may be a mobile communication network. Furthermore, a mobile wireless communication device 20 is shown which includes a hardware security device 170 that may also be referred to as a security token, as shown in FIG. 4. It goes without saying that the communication system 10 may comprise a plurality of mobile wireless communication devices. The wireless mobile communication device 20 may, for example, be a smartphone, which may have functions of conventional smartphones. In this case, the hardware security device 170 may include SIM card functionality. It should be noted that the mobile wireless communication device 20 may also perform functions of a conventional smartphone. Among other things, the hardware security device 170 serves to identify the mobile wireless communication device 20. For this purpose, a unique identifier may be stored in a memory 174. The hardware security device 170 may furthermore include a program memory 172 which may have stored therein instructions for performing various security functions and/or cryptographic functions.

Memory 174 may furthermore have stored therein the security keys needed to perform a cryptographic function. Hardware security device 170 is controlled by a control unit 173 which may be a microcontroller or a microprocessor, as shown in FIG. 4. Furthermore, hardware security device 170 has a communication interface 171 as known per se, via which it can communicate with the mobile wireless communication device 20. As shown in FIG. 4, mobile wireless communication device 20 may furthermore comprise an input and/or output device 23 and a control unit 22 which controls the functions of the mobile wireless communication device 20. For example, information stored in the memory 174 of hardware security device 170 can be displayed via the input and/or output device 23. Preferably, the access to hardware security device 170 is protected by a password.

As shown in FIG. 4, the mobile wireless communication device 20 has a wireless communication interface 21, through which it can communicate directly via the mobile communication network 140. Furthermore, the mobile wireless communication device 20 may have at least one further wireless communication interface 24 which is configured according to the NFC standard, the Bluetooth standard, or the WLAN standard, for example. In the present example it will be assumed that the wireless communication interface 24 is configured for communication with public stationary WLAN access points. FIG. 1 only illustrates one public stationary access point 40. Via stationary access point 40, the mobile wireless communication device 20 is able to access the Internet 60.

At least one data management device is connected to the communication network 60. For ease of illustration, only two data management devices 70 and 80 are shown in FIG. 1.

FIG. 5 shows an exemplary block diagram of the data management device 70. Data management device 70 preferably comprises a control unit 74 which may be configured as a microprocessor or microcontroller. Furthermore, an information memory 72 is provided, which can store at least one piece of information which is intended for the mobile wireless communication device 20 in the present example, and which can be transmitted to the mobile wireless communication device 20 by executing a corresponding communication task. The information stored in information memory 72 is preferably encrypted.

It should be noted at this point already, that a unique association is existing between the mobile wireless communication device 20 and the data management device 70. This means that the data management device 70 can transmit information only to the hardware security device 170 of the mobile communication device 20, and, vice versa, the hardware security device 170 of the mobile communication device 20 can transmit information only to the data management device 70. This unique association can be achieved, for example, by having the IP address of the data management device 70 stored in the mobile wireless communication device 20, preferably in the memory 174 thereof, and by the fact that the data management device 70 can uniquely identify only the mobile communication device 20.

As shown in FIG. 5, data management device 70 furthermore comprises a program memory 73 which contains instructions that can be executed by the microprocessor 74 to control the data management device 70, inter alia. For example, program memory 73 may have stored therein an algorithm which when being executed by control unit 74 ensures, for example, that different communication tasks can be processed according to a priority list, i.e. in a predetermined order. For example, a communication task associated with information destined for the mobile wireless communication device 20 may be executed at a higher priority than, for example, a communication task concerning information that is to be transferred from the hardware security device 170 of the mobile wireless communication device 20 to the data management device 70. Data management device 70 may have a further communication interface 75 which is in particular used for programming the data management device 70. Preferably, communication interface 75 can be used to write into the information memory 72 encrypted information which is intended for the hardware security device 170 of the mobile wireless communication device 20.

Mobile wireless communication device 20 is configured to be responsive to a predetermined repetitive event to initiate, in each case, the establishment of a temporarily limited communication connection via the at least one communication network 60 from the hardware security device 170 to the data management device 70, and to identify to the data management device 70. Data management device 70 is configured to check whether there is a communication task waiting concerning the wireless communication device 20 or the hardware security device 170. If there is a communication task to transfer information to the hardware security device 170 of mobile wireless communication device 20, the microprocessor 74 of data management device 70 controls the execution of the communication task, after successful identification of the wireless communication device 20, by reading out data from information memory 72 and transmitting them in secured manner via the established communication connection.

An exemplary predetermined repetitive event, with respect to FIG. 1, may for instance be a point in time as detected by the mobile wireless communication device 20, at which the mobile wireless communication device 20 enters the coverage area of the wireless stationary access point 40. Once the mobile communication device 20 has entered the coverage area of the stationary access point 40, the mobile wireless communication device 20 initiates the establishment of a connection to the data management device 70 via the stationary access point 40 using the IP address of the data management device 70, and the hardware security device 170 identifies to the data management device 70. In order to provide for a secured and automated communication between the data management device 70 and the hardware security device 170 of the mobile secure communication device it is possible, for example, to have the IP Security (IPsec) technology in conjunction with the Message Authentication Code Technology implemented in the hardware security device 170 and in the data management device 70. This makes it possible to exchange information between the data management device 70 and the hardware security device 170 in an authentical, integrity-secured, and trustworthy manner in the sense of an end-to-end communication.

As further shown in FIG. 1, the exemplary communication system 10 comprises another wireless communication device which is configured as a stationary wireless communication device 30 in the present example. Of course, further stationary communication devices can be provided as well.

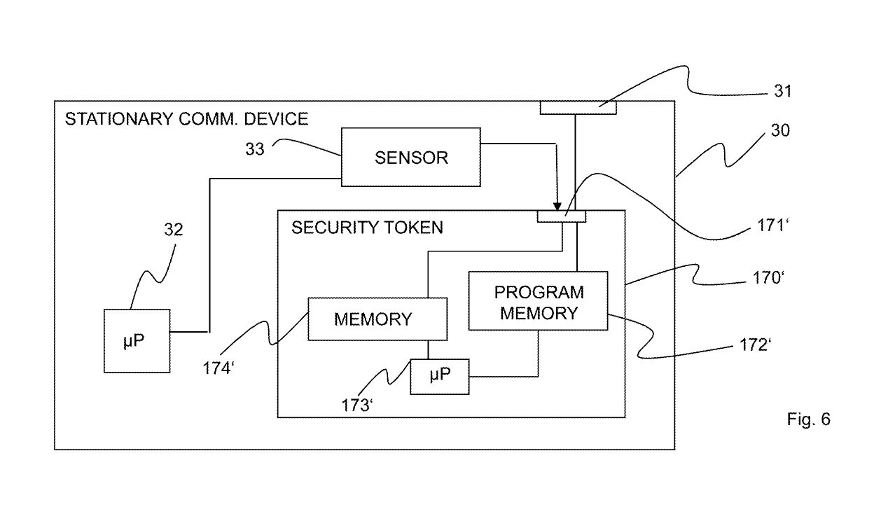

Stationary wireless communication device 30, which is shown in more detail in FIG. 6, may comprise a sensor 33 which may be installed stationarily in a lamp or a traffic light at a roadside, for example. Sensor 33 may detect temperature, traffic density, or other parameters, for example. Similarly to the mobile wireless communication device 20, stationary wireless communication device 30 includes a hardware security device 170′ comprising a memory 174′, a control unit 173′ which may be configured as a microprocessor, a program memory 172′, and a communication interface 171′ through which the hardware security device 170′ can communicate with the stationary wireless communication device 30. Configuration and operation of hardware security device 170′ may correspond to that of hardware security device 170 of the mobile wireless communication device 20 shown in FIG. 4. To avoid repetition, reference is made to the above description thereof.

As shown in FIG. 6, stationary wireless communication device 30 furthermore has a wireless communication interface 31 which may be configured according to the Bluetooth standard, the NFC standard, or the WLAN standard, for example. In the present example, the wireless communication interface 31 is configured in accordance with the WLAN standard in order to be able to communicate in wireless manner with a mobile public access point 50. The mobile public access point 50 may be implemented in a vehicle, for example. Via the mobile public access point 50 and the mobile communication network 140, the hardware security device 170′ may gain access to the Internet 60, for example.

In the exemplary embodiment shown in FIG. 1, the stationary wireless communication device 30 is uniquely associated with a data management device 80 that may be configured and operated similarly to the data management device 70. This means that the data management device 80 has a control unit, an information memory, a program memory, and a communication interface for connection to the Internet 60. Similarly to data management device 70, the data management device 80 may have a further communication interface which is in particular used for programming the data management device 80. Preferably, encrypted information intended for the hardware security device 170′ of stationary wireless communication device 30 can be written into the information memory via this communication interface.

The hardware security device 170′ of stationary wireless communication device 30 is configured to be responsive to a predetermined repetitive event to initiate, in each case, the establishment of a temporarily limited communication connection via the mobile access point 50, the mobile communication network 140, the Internet 60 to the data management device 80. Such a predetermined possibly repetitive event is, for example, the point in time at which a vehicle including the mobile access point 50 passes by the stationary wireless communication device 30 so that the stationary wireless communication device 30 can enter the coverage area of the mobile access point 50. In response thereto, the stationary wireless communication device 30 or the hardware security device 170′ then initiates the establishment of a connection to the data management device 80 using the IP address of the data management device 80, which is stored in memory 174′, for example. Subsequently, the hardware security device 170′ or the stationary wireless communication device 30 can identify to the data management device 80. Similarly to data management device 70, the data management device 80 is configured to check whether there is a communication task waiting concerning the wireless communication device 30. If so, it controls the execution of the communication task, after successful identification of the wireless communication devices 30, by reading out data from its memory and transmitting them to the hardware security device 170′ in secured manner, via the established communication connection.

The data management devices 70 and 80 can each check whether a communication task has been completely executed during an established communication connection. If not, the execution of the communication task is continued during at least one further communication connection established between hardware security device 170 and data management device 70 and/or between hardware security device 170′ and data management device 80. The execution of a communication task may be interrupted when, for example, the communication connection between a mobile wireless communication device and the data management device associated therewith breaks down because the mobile wireless communication device 20 has moved out of the coverage area of the stationary access point 40, for example. A further communication connection, for example between the hardware security device 170 and the data management device 70, can be established as soon as the mobile wireless communication device 20 has again moved into the coverage area of a stationary access point, for example.

It should be noted at this point that the stationary access point 40, of which only a single one is illustrated for the sake of simplicity, may for example also be an NFC reading device which provides access to the Internet 60 via an NFC background system. In this case, the mobile wireless communication device 20 may be configured as a key and may include an NFC interface 24 with an NFC chip. As soon as the mobile wireless communication device 20 enters the coverage area of the stationary NFC access point 40, the mobile wireless communication device 20 is able to establish a connection to the data management device 70 via the Internet 60.

The operation of communication system 10 will be explained in more detail further below.

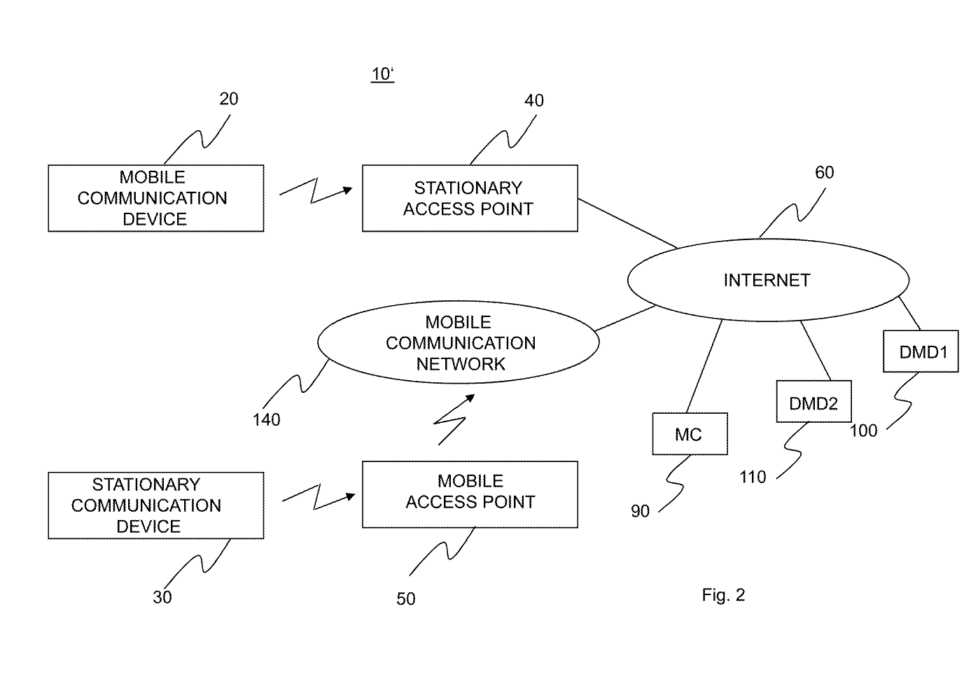

FIG. 2 shows an alternative communication system 10′, which in particular differs from the communication system 10 illustrated in FIG. 1 by having a central management device 90, also referred to as management center MC herein, connected to the Internet 60. The mobile communication device 20 shown in FIG. 2, the stationary access point 40, the stationary wireless communication device 30, the mobile access point 50, the mobile communication network 140, and the Internet 60 correspond to the respective entities of the communication system 10 shown in FIG. 1. Furthermore, two data management devices 100 and 110 are connected to the Internet 60, by way of example. The two data management devices 100 and 110 differ from data management devices 70 and 80 by the fact that they do not carry out any identification or authentication procedures with the respective wireless communication device 30 or 20 they are associated with. This task is performed by the central management device 90. In the discussed example, the mobile wireless communication device 20 is uniquely associated with data management device 110, while the stationary wireless communication device 30 is uniquely associated with data management device 100.

In contrast to communication system 10, both the memory 174 of hardware security device 170 and the memory 174′ of hardware security device 170′ has stored therein the IP address of the central management device 90. Central management device 90, in turn, may have stored therein a mapping table which includes the IP address of data management device 100, the IP address of data management device 110 and a unique identifier of hardware security device 170 and of hardware security device 170′, and optionally an address of stationary access point 40 and an address of mobile access point 50, so as to be able to make a unique association between the mobile wireless communication device 20 and data management device 110, as well as between the stationary wireless communication device 30 and data management device 100.

Wireless communication device 20 is configured to be responsive to a predetermined repetitive event and by using the IP address of the central management device 90 to initiate the establishment of a communication connection via the stationary access point 40 and the communication network 60 to the central management device 90 and to identify to the central management device. Central management device 90 is configured to control, after a successful identification of the mobile wireless communication device 20, the establishment of a temporarily limited communication connection between the hardware security device 170 of wireless communication device 20 and the data management device 110 which is uniquely associated with the mobile wireless communication device 20 via the stationary access point and the Internet 60. Data management device 110 is configured to check whether there is a communication task waiting concerning the mobile wireless communication device 20. If so, the data management device controls the execution of the communication task by transferring, in secured manner, information stored in its memory and intended for hardware security device 170 to the hardware security device 170 via the established communication connection. Transfer in secured manner again means that the information is transferred between the hardware security device 170 of the mobile wireless communication device 20 and the data management device 110 in an authentical, integrity-secured, and confidential manner over the entire communication path.

Information for the hardware security device 170 of the mobile wireless communication device 20 is stored, preferably in encrypted form, in an information memory of data management device 110, while information for the hardware security device 170′ of the stationary wireless communication device 30 is stored, preferably in encrypted form, in an information memory of data management device 100.

As already discussed with respect to communication system 10, the predetermined repetitive event may be the point(s) in time at which the mobile wireless communication device 20 enters the coverage area of the stationary access point 40 or another stationary access point, not illustrated.

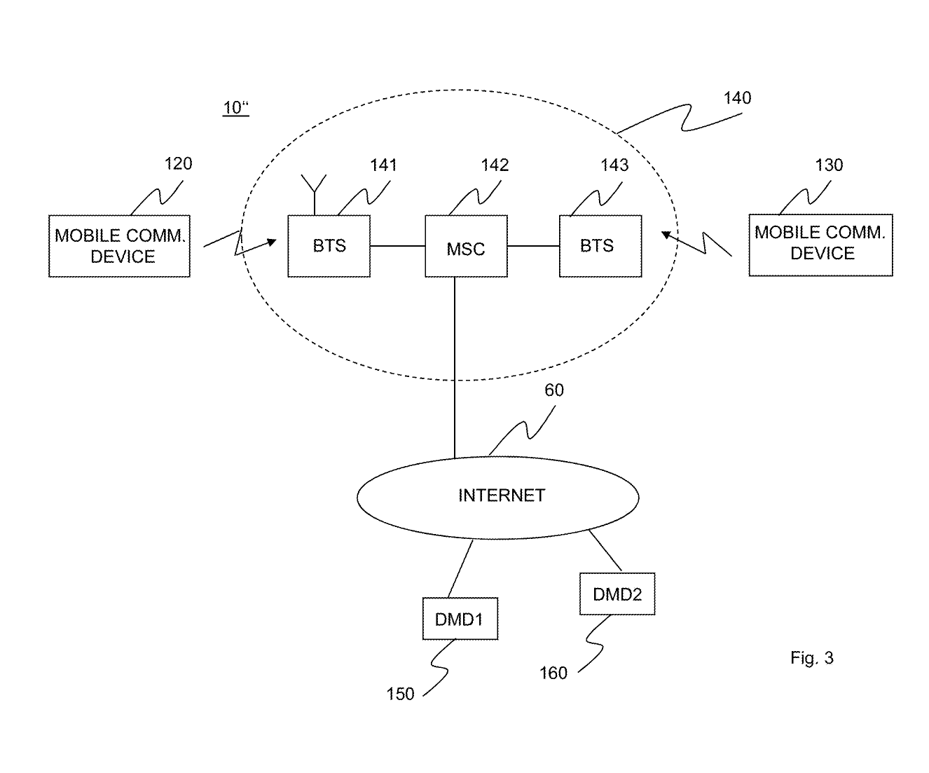

FIG. 3 shows a further exemplary communication system 10″ in which, for example, two wireless communication devices 120 and 130 can directly communicate with a data management device 150 and 160, respectively, that means via the mobile communication network 140 and the Internet 60 without having access points interconnected therebetween. It should be noted that the illustrated exemplary communication systems 10, 10′, and 10″ can be operated individually, but also in combination. This fact is in particular indicated by the use of identical reference numerals for the two communication networks 60 and 140.

The mobile communication network 140 used by way of example in the discussed communication systems 10, 10′, 10″, and 10′″ is schematically represented by two Base Transceiver Systems 141 and 143, referred to as BTS for short, and a Mobile service Switching Center 142, referred to as MSC for short. In a manner known per se, a connection to the Internet 60 can be established via the mobile service switching center 142. It should be noted that the configuration and operation of the two mobile wireless communication devices 120 and 130 can be similar to that of the mobile wireless communication device 20 shown in FIG. 4. The wireless communication interface designated by 21 in FIG. 4 is used to communicate over the mobile communication network 140 in this case. It should be noted again, that for ease of illustration only two mobile wireless communication devices 120 and 130 and two data management devices 150 and 160 are illustrated. In the present example it is assumed that the mobile wireless communication device 120 is uniquely associated with data management device 150, while the mobile wireless communication device 130 is uniquely associated with data management device 160.

The two mobile wireless communication devices 120 and 130 are each configured to be responsive to a predetermined preferably repetitive event to initiate, in each case, the establishment of a temporarily-limited communication connection via the mobile communication network 140 and the Internet 60 to the data management device 150 and to the data management device 160, respectively, and to identify to the data management device 150 and 160, respectively. The predetermined repetitive event can, for example, be a time trigger, which is, for example, triggered by the microprocessor of the hardware security device of mobile communication device 120 or 130, respectively. An established communication connection is temporarily limited, for example, by having the connection terminated after a fixed period of time or a randomly selected period of time by the microprocessor controlled by the respective hardware security device.

Data management devices 150 and 160 are each configured to check whether there is a communication task waiting concerning the wireless communication device 120 or 130. If so, the communication task is controlled by the respective data management device 150 or 160, after successful identification of the wireless communication device 120 or 130, by transmitting information in secured and selective manner via the respective established communication connection to the hardware security device of the mobile wireless communication device 120 or 130.

The data management devices 150 and 160 are each configured to check whether the communication task has been completely executed during an established secure communication connection. If not, the execution of the respective communication task is continued during at least one further connection established between the respective hardware security device of the wireless communication device 120 or 130 and the data management device 150 or 160, respectively.

It should be noted at this point that the hardware security device 170 of mobile wireless communication devices 20, 120, and 130 and the hardware security device 170′ of stationary mobile communication device 30 are each configured to transmit status information to the respective uniquely associated data management device, preferably at the beginning, i.e. immediately after the establishment of a communication connection, which status information indicates that a piece of information has not yet been completely transferred. Alternatively or additionally, the status information may indicate at which point the information transfer broke down previously. In addition, each hardware security device may transmit status information to the respective data management device, which status information signals that a communication task has been completely executed, that means the information associated with the communication task has been completely received and possibly processed.

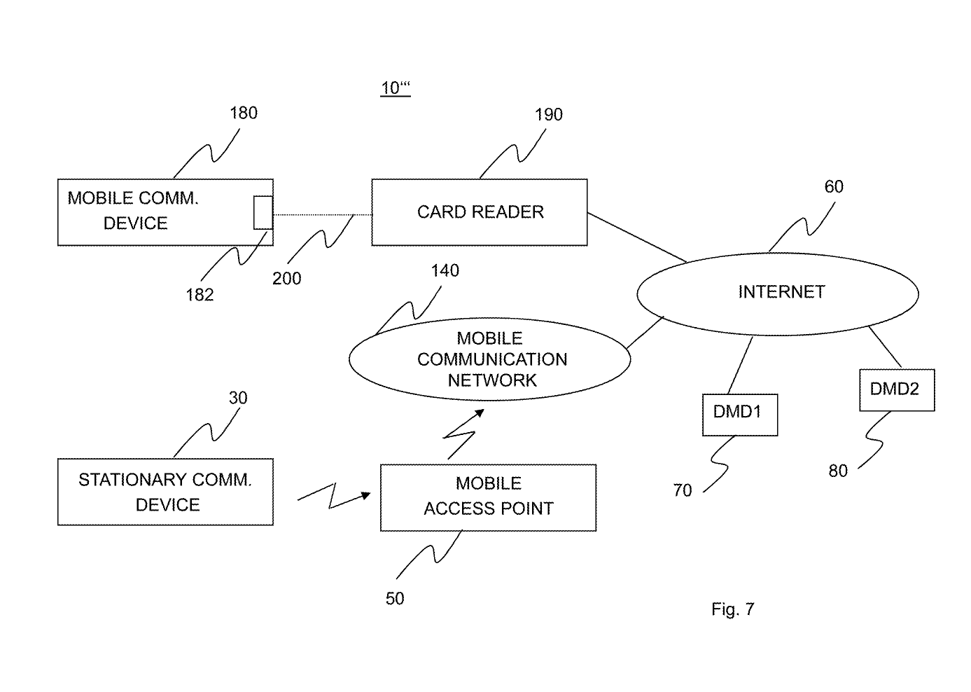

FIG. 7 illustrates part of a further exemplary communication system 10′″ for secured and automated communication between a data management device and a hardware security device of a communication device. Communication system 10′″ differs from the communication system 10 shown in FIG. 1 only by the fact that instead of the mobile wireless communication device 20, a mobile contact-based communication device 180 is used, and that instead of the stationary wireless access point 40, a contact-based device is used, for example a contact-based card reader 190. Mobile contact-based communication device 180, which may be a chip card, for example, is uniquely associated with the data management device 70. Instead of the wireless communication interface 21 of mobile wireless communication device 20, the mobile contact-based communication device 180 has a contact-based communication interface 182 for contact-based communication with the card reader 190. The contact-based communication is symbolized by the dotted line 200. Otherwise, the configuration and operation of the contact-based communication device 180 substantially corresponds to the configuration and operation of the mobile wireless communication device 20 as illustrated in FIG. 4. That is to say, the contact-based communication device 180 may include an input and/or output device, a control unit controlling the operation of the contact-based communication device 180, and a hardware security device with a memory, a program memory, and a control unit, like the mobile wireless communication device 20. It should be noted that the card reader 190 may also have a wireless communication interface for communication with a mobile wireless communication device such as the communication device 20.

The contact-based communication device 180 is configured to detect, as an event, an electrical connection or electrical contact to the contact-based card reading device 190 and to initiate, in response thereto, the establishment of a communication connection via the contact-based card reading device 190 to the data management device 70.

When the contact-based communication device 180 is electrically disconnected from the contact-based card reading device 190, a communication connection existing between the hardware security device of the contact-based communication device 180 and the data management device 70 breaks down. As soon as the contact-based communication device 180 is again electrically connected to the card reading device 190 or to another suitable contact-based device connected to the Internet 60, a communication connection can again be established between the hardware security device of the contact-based communication device 180 and the data management device 70 in order to execute a new communication task in secured manner or to continue a communication task that has not yet been completely executed. This method will be explained in more detail further below in conjunction with the communication system shown in FIG. 1.

If, for example, the mobile contact-based communication device 180 and at least the one card reading device 190 are used in FIG. 2, the contact-based communication device 180 may be configured to detect an electrical connection or an electrical contact to the contact-based card reading device 190 and to be responsive thereto by initiating the establishment of a communication connection via the contact-based card reading device 190 to a data management device to which it is uniquely associated, or to the central management device 90.

It should be noted that instead of the stationary wireless communication device 30 it is also possible to use a stationary contact-based communication device including a hardware security device which is capable of communicating in secured manner with the data management device 80, for example via a mobile contact-based reading device that can be connected to the Internet 60 via the mobile communication network 140.

It should be noted that the communication systems 10, 10′, 10″, and 10′″ illustrated by way of example can be combined in any desired way. Stated in other words, the communication systems may include a plurality of mobile wireless communication devices 20, and/or a plurality of stationary wireless communication devices 30, and/or a plurality of mobile contact-based communication devices 180, and/or a plurality of stationary contact-based communication devices, and/or a plurality of wireless stationary access points 40, and/or a plurality of mobile wireless access points 50, and/or a plurality of stationary contact-based devices 190, and/or a plurality of mobile contact-based devices, and/or at least the one central management device 90.

Now, the operation of the communication system 10 shown in FIG. 1 will be explained in more detail. The following description of operation also applies to the communication system 10′″ shown in FIG. 7 if the mobile wireless communication device 20 is replaced by the mobile contact-based communication device 180 and the wireless stationary access point 40 by the preferably stationary contact-based card reader 190.

Assuming, for example, that the memory 174 of hardware security device 170 and the memory 174′ of hardware security device 170′ each have a cryptographic key stored therein, which can be used by the respective hardware security device to encrypt information that is to be transmitted. In order to ensure that encrypted information cannot be intercepted, provision may be made to replace the cryptographic keys at specified points in time.

Assuming further that an administrator has stored a new cryptographic key for the hardware security device 170 of mobile wireless communication device 20 in encrypted form in the information memory 72 of data management device 70, via the communication interface 75, which is signaled to the data management device 70 by a corresponding communication task. Similarly, a new cryptographic key for the stationary wireless communication device 30 has moreover been stored in encrypted form in the information memory of data management device 80. The respective associated communication task defines, for example, that the cryptographic key stored in the respective information memory is to be transmitted to the mobile wireless communication device 20 or to the stationary wireless communication device 30, respectively, and that the old key is to be replaced by the new key.

Assuming further that the mobile wireless communication device 20 has just entered the coverage area of the stationary access point 40, while the stationary wireless communication device 30 has entered the coverage area of the mobile access point 50.

In response to the entry into the coverage area of stationary access point 40, the hardware security device 170 of mobile communication device 20 initiates the establishment of a communication connection to data management device 70 over at least one communication network, in the present example over the Internet 60 and the stationary access point 40 for a time interval of limited length.

For this purpose, the mobile wireless communication device 20 can use the IP address of data management device 70.

Similarly, a communication connection is established between data management device 80 and the hardware security device 170′ of the stationary wireless communication device via at least one communication network, in the present example via the mobile access point 50, mobile communication network 140, and the Internet 60 for a time interval of limited length.

Using a unique electronic identifier, the mobile wireless communication device 20 or the hardware security device 170 now identifies to the data management device 70, while the stationary wireless communication device 30 or the hardware security device 170′ identifies to the data management device 80. For this purpose, authentication methods can be used that are known per se. In particular, hardware security devices 170 and 170′ of wireless communication device 20 or 30, respectively, and data management devices 70 and 80 are configured to preferably use the IP Security technology and the Message Authentication Code technology to provide for secure communication between the hardware security device 170 of mobile wireless communication device 20 and the data management device 70, and between the hardware security device 170′ of stationary wireless communication device 30 and the data management device 80 to transfer information in authentic, integrity-secured, and confidential manner. The identification of the wireless communication devices 20 and 30 to the respective data management device 70 and 80 they are uniquely associated with is appropriately carried out via the previously established communication connections.

Data management devices 70 and 80 each check whether there is a communication task waiting concerning the wireless communication device 20 or the wireless communication device 30. In the present example, there is a communication task waiting in each case, namely to transfer the key stored in information memory 72 to hardware security device 170 of mobile wireless device 20 and to replace the old key, and to transfer the cryptographic key stored in the data management device to hardware security device 170′ of stationary wireless communication device 30 and to replace the old key. After successful identification of the mobile wireless communication device 20, data management device 70 then controls the execution of the communication task by reading out the new cryptographic key from memory 72 and transmitting it, in secured manner, to hardware security device 170 via the established communication connection. Similarly, the new cryptographic key stored in memory 72′ of data management device 80 is read out and transmitted, in secured manner, to hardware security device 170′ via the established communication connection.

Data management devices 70 and 80 now each check whether the respective communication task has been completely executed during the established communication connection. If it turns out that the communication connections broke down earlier, data management devices 70 and 80 each wait for the mobile wireless communication device 20 or the stationary wireless communication device 30 to again establish a communication connection. As soon as the mobile wireless communication device 20 and the stationary wireless communication device 30 again enter the coverage area of a stationary access point or of a mobile access point, the method described above is repeated. Appropriately, once a communication connection has been reestablished, the hardware security device 170 and the hardware security device 170′ of data management device 70 and of data management device 80, respectively, will transmit status information signaling at which point the execution of the communication task has broken down or which data was transmitted last. In this way, data management devices 70 and 80 are each capable of transferring the data not yet received by the mobile communication device 20 and the stationary communication device 30 to the hardware security device 170 of mobile wireless communication device 20 and to the hardware security device 170′ of stationary communication device 30, respectively.

As soon as all data of the respective communication task have been received by the respective hardware security device 170 or 171, the respective hardware security device transmits corresponding status information to data management device 70 or to data management device 80 signaling that all data have been received. This means that the respective communication task has been completely executed.

It is conceivable in this case that the data management devices 70 and 80 transmit a respective corresponding end signal to the respective hardware security device after complete execution of a communication task, based on which the respective hardware security device can identify the complete receipt of a piece of information.

If, for example, the data management device 70 has identified that a communication task has been completely executed, that is to say that all data representing the cryptographic key have been completely received by the hardware security device 170, the data management device 70 may terminate the communication connection before the mobile wireless communication device 20 leaves the coverage area of the stationary access point.

Thanks to this method it is possible to transfer, in secured manner, security-relevant data from the data management device 70 to the hardware security device 170 and/or from the data management device 80 to the hardware security device 170′ even during very short communication connections, for example of a few seconds or even shorter.

Now, assuming the case that several pieces of information or types of information are stored in the information memory 72 of data management device 70, which are defined by a respective communication task.

Assuming, for example, that the information memory 72 has stored therein, in encrypted form, a security update for a security software stored in the program memory 172 of hardware security device 170, a short message, and special control information. The different types of information may have been provided with a respective flag by the administrator, based on which the microprocessor 74 of data management device 70 can identify in which order the respective pieces of information must be transmitted to the hardware security device 170. In other words, data management device 70 can automatically make a prioritization of the information to be transmitted. Assuming, in the present example, that the security update has highest priority, followed by the control information and the short message. Furthermore, assuming that the memory 174 of the hardware security device 170 has information stored therein, which is intended for data management device 70.

After a communication connection between the hardware security device 170 of the mobile wireless communication device 20 and the data management device 70 has been established for the first time in the manner described above and the mobile wireless communication device 20 has identified to the data management device 70, the data management device 70 checks whether there are communication tasks waiting to be executed. Since the mobile wireless communication connection 20 now also has information for the data management device 70, it transmits a corresponding communication task to the data management device 70. The latter assigns, for example, the lowest priority to this communication task. Now, the data management device 70 starts executing the communication task which has the highest priority. The method described above, that is to say the possibly repeated establishment of communication connections and identifying of the mobile secure communication device 20 to the data management device 70 and subsequent transmission of the information associated with the respective communication task in an authentic, integrity-secured, and confidential manner is repeated until all communication tasks have been completely executed.

In this way, it is ensured that information is completely transferred via an authentic, integrity-assured, and confidential end-to-end communication both from the hardware security device 170 of mobile wireless communication device 20 to the data management device 70 and vice versa, from the data management device 70 to the hardware security device 170.

The operation of the communication system shown in FIG. 3 substantially corresponds to the operation of the communication system of FIG. 1 that has just been described, but in this case the mobile wireless communication devices 120 and 130 establish communication connections to the respective data management device 150 or 160 directly via the mobile communication network 140 and the Internet, without any access points therebetween. For the sake of completeness, it should be mentioned that the communication system shown in FIG. 3 may also include a central management device which functions similarly to the central management device 90 of communication system 10′.

The operation of the communication system 10″ shown in FIG. 3 is similar to the operation of communication system 10. However, the mobile communication devices 120 and 130 do not establish communication connections in indirect manner via stationary access points, but directly, via the mobile communication network 140 and the Internet 60 to the data management device 150 or 160, respectively, that means without having stationary access points interconnected therebetween, and securely exchange information in the manner described above.

The operation of the communication system 10′ shown in FIG. 2 will now be explained with reference to an exemplary embodiment.

As in the example explained above, it will be assumed that a new cryptographic key for the mobile hardware security device 170 of wireless communication device 20 is available in data management device 110.

Assuming again that the mobile wireless communication device 20 has just entered the coverage area of the stationary access point 40. In response thereto, a communication connection is established between the central management device 90 and the hardware security device 170 of the mobile wireless communication device 20, preferably under control of the mobile communication device 20, via at least one communication network, in the present example via the stationary access point 40 and the Internet 60. For this purpose, the mobile wireless communication device 20 uses the IP address of the central management device stored in memory 174. Subsequently, the mobile wireless communication device 20 identifies to the central management device 90 using the electronic unique identifier stored in hardware security device 170.

After successful identification, the central management device 90 identifies that the mobile communication device 20 is uniquely associated with data management device 110. In response thereto, the central management device 90 controls the establishment of a communication connection between the data management device 110 and the hardware security device 170 of mobile wireless communication device 20 via the stationary access point 40 and the Internet 60. The communication connection exists during a time interval of limited length, i.e., for example, as long as the mobile wireless communication device 20 is located in the coverage area of stationary access point 40. Now, the data management device 110 checks whether there is a communication task waiting concerning the wireless communication device 20. If so, the communication task is executed under control of the data management device 110 by transferring the new cryptographic key stored in information memory 72 to the hardware security device 170 via the established communication connection.

If the communication connection breaks down, for example because the mobile wireless communication device 20 has left the coverage area of stationary access point 40, and if no status information has been received in the data management device 110 from hardware security device 170 indicating the complete receipt of the data, the data management device 110 waits for establishment of a new communication connection. As soon as the mobile wireless communication device 20 again enters the coverage area of a stationary access point, not illustrated, a communication connection is again established from the hardware security device 170 of mobile wireless communication device 20 to the central management device 90 using the IP address of the central management device 90, and an identification of the wireless communication device 20 to the central management device 90 is performed. Subsequently, a communication connection is again established in the manner described above between the hardware security device 170 of the mobile wireless communication device 20 and the data management device 110, under control of the central management device 90, in order to continue execution of the communication task, that is to read, from information memory 72, the data that have not yet been received by the hardware security device 170, and to transfer them to the mobile wireless communication device 20, i.e. to hardware security device 170. These steps are repeated until all data have been received in the hardware security device 170. Secured communication between the hardware security device 170′ of stationary communication device 30 and the data management device 100 is performed similarly, under assistance of the central management device 90.

It should furthermore be noted that the information received in the mobile wireless communication device 20 from the respective data management device may be visualized, for example via input/output device 23, or may be made available for further processing via communication interface 171. It should also be noted that the stationary wireless communication device 30 may also have such input/output devices.

### LIST OF REFERENCE NUMERALS

10-10′″ Communication system
20 Mobile wireless communication device
21 Wireless communication interface
22 Control unit, e.g. microprocessor
23 Input and/or output device
24 Wireless communication interface
30 Stationary wireless communication device
31 Wireless communication interface
32 Control unit, e.g. microprocessor
33 Sensor
40 Stationary wireless access point
50 Mobile wireless access point
60 First communication network, e.g. the Internet
70 Data management device
71 Communication interface, in particular for connection to a communication network
72 Information memory
73 Program memory
74 Control unit, e.g. microprocessor
75 Communication interface, in particular for programming the data management device
80 Data management device
90 Central management device
100, 110 Data management device
120, 130 Mobile wireless communication device
140 Second communication network, e.g. a mobile communication network
141, 143 BTS, Base Transceiver System
142 MSC, Mobile Service Switching Center
150, 160 Data management device
170, 170′ Hardware security device, e.g. a security token
171, 171′ Communication interface
172, 172′ Program memory
173, 173′ Control unit, e.g. microprocessor
174, 174′ Data memory
180 Mobile contact-based communication device
182 Contact-based communication interface
190 Card reading device
200 Contact-based communication connection

1. A method for secured and automated communication between a data management device and a hardware security device of a communication device in a communication system which comprises at least one communication network, comprising the steps of:
a) initiating, by the communication device, in response to a predetermined event, an establishment of a communication connection between the data management device and the hardware security device arranged in the communication device via the at least one communication network for a time interval of limited length, wherein the data management device and the communication device are uniquely associated with each other such that information can only be transferred from the hardware security device to the data management device and vice versa, and wherein the hardware security device is configured for identifying the communication device;
b) identifying the communication device to the data management device;
c) checking, in the data management device, whether there is a communication task waiting concerning the communication device;
d) if so, and after successful identification, executing the communication task under control of the data management device by transferring data in secured manner via the communication connection established in step a).

2. The method as claimed in claim 1, further comprising the steps of:
e) checking, in the data management device, whether the communication task has been completely executed during the communication connection established in step a);
f) if not, repeating steps a), b), d), and e) until the communication task has been completely executed.

3. A method for secured and automated communication between a data management device and a hardware security device of a communication device in a communication system which comprises at least one communication network, comprising the steps of:
a) initiating, by the communication device, in response to a predetermined event, an establishment of a communication connection between a central management device and the hardware security device implemented in the communication device via the at least one communication network, wherein the hardware security device is configured for identifying the communication device;
b) identifying the communication device to the central management device;
c) after successful identification, establishing a communication connection between a data management device and the hardware security device of the communication device under control of the central management device via the at least one communication network for a time interval of limited length, wherein the data management device and the communication device are uniquely associated with each other such that information can only be transferred from the hardware security device to the data management device and vice versa;
d) checking, in the data management device, whether there is a communication task waiting concerning the communication device;
e) if so, and after successful identification, executing the communication task under control of the data management device by transferring data in secured manner via the communication connection established in step c).

4. The method as claimed in claim 3, further comprising the steps of:
f) checking, in the data management device, whether the communication task has been completely executed during the secure communication connection established in step c);
g) if not, repeating steps a) to c), e), and f) until the communication task has been completely executed.

5. The method as claimed in claim 1,
wherein the communication device is a wireless communication device, and in step a) a communication connection can be established via a wireless access point of the communication system as soon as the wireless communication device enters the coverage area of the wireless access point; or
wherein the communication device is a contact-based communication device and in step a) a communication connection can be established via a contact-based device of the communication system as soon as the contact-based communication device has been electrically connected to the contact-based device.

6. The method as claimed in claim 3,
wherein the communication device is a wireless communication device, and in steps a) and c) a respective communication connection can be established via a wireless access point of the communication system as soon as the wireless communication device enters the coverage area of the wireless access point; or
wherein the communication device is a contact-based communication device, and in steps a) and c) a respective communication connection can be established via a contact-based device of the communication system as soon as the contact-based communication device has been electrically connected to the contact-based device.

7. The method as claimed in claim or 6,
wherein the wireless communication device is mobile and the wireless access point is stationary; or
wherein the wireless communication device is stationary and the wireless access point is mobile.

8. The method as claimed in claim 3, wherein status information is transmitted from the communication device to the data management device, which status information signals that the communication task has been executed completely.

9. The method as claimed in any of the preceding claims claim 4,
wherein the communication task indicates that there is information which is to be transmitted to the hardware security device of the communication device; and
wherein steps a) to c), e), and f) are repeated until all information has been transmitted to the hardware security device of the communication device.

10. The method as claimed in claim 9, wherein the information to be transmitted to the hardware security device of the communication device is stored in encrypted form in the data management device.

11. The method as claimed in claim 9, wherein the information to be transmitted to the hardware security device of the communication device, contains security-related data, in particular security updates for a security software stored in the hardware security device.

12. The method as claimed in claim 3,
wherein there are different communication tasks waiting in the data management device;
wherein at least one of the communication tasks may relate to the transmitting of information from the hardware security device of the communication device, to the data management device; and
wherein the execution of the different communication tasks is controlled by the data management device in prioritized manner.

13. The method as claimed in claim 3, wherein a communication connection established in step c) can be terminated by the data management device if there is no communication task waiting in the data management device.

14. A communication system for secured and automated communication between a data management device and a hardware security device of a communication device, comprising the following features:
at least one communication network;
a communication device including a hardware security device for identifying the communication device;
a data management device uniquely associated with the communication device such that information can only be transferred from the hardware security device to the data management device and vice versa;
wherein the data management device includes a memory device which can store at least one piece of information for the hardware security device of the communication device;
wherein the communication device is configured to be responsive to a predetermined repetitive event to initiate, in each case, establishment of a temporarily limited communication connection via the at least one communication network from the hardware security device to the data management device, and to identify to the data management device;
wherein the data management device is configured
to check whether there is a communication task waiting concerning the communication device;
if so, and after successful identification of the communication device, to control the execution of the communication task by transferring data in secured manner via the respective established communication connection.

15. A communication system for secured and automated communication between a data management device and a hardware security device of a communication device, comprising the following features:
at least one communication network;
a central management device;
a communication device including a hardware security device for identifying the communication device;
a data management device uniquely associated with the communication device such that information can only be transferred from the hardware security device to the data management device and vice versa;
wherein the data management device includes a memory device which can store at least one piece of information for the hardware security device of the communication device;
wherein the communication device is configured to be responsive to a predetermined repetitive event to initiate, in each case, establishment of a communication connection via the at least one communication network from the hardware security device to the central management device, and to identify to the central management device;
wherein the central management device is configured, after successful identification of the communication device, to control establishment of a temporarily limited communication connection between the hardware security device of the communication device and the data management device via the at least one communication network;
wherein the data management device is configured
to check whether there is a communication task waiting concerning the communication device; and
if so, to control the execution of the communication task by transferring data in secured manner via the respective established communication connection.

16. The communication system as claimed in claim 15, wherein the data management device is configured to check whether the communication task has been completely executed during an established secure communication connection, and if not, to continue the execution of the communication task during at least one further communication connection established between the hardware security device of the communication device and the data management device.

17. The communication system as claimed in claim 15,
comprising at least one wireless access point connected to the at least one communication network, wherein the communication device is a wireless communication device and is configured to detect the entry into the coverage area of the at least one wireless access point and in response thereto to establish a communication connection via the wireless access point to the data management device or to the central management device; or
comprising at least one contact-based device connected to the at least one communication network, wherein the communication device is a contact-based communication device and is configured to detect an electrical connection to the at least one contact-based device and in response thereto to establish a communication connection via the contact-based device to the data management device or to the central management device.

18. The communication system as claimed in claim 14, wherein the data management device is configured to check whether the communication task has been completely executed during an established secure communication connection, and if not, to continue the execution of the communication task during at least one further communication connection established between the hardware security device of the communication device and the data management device.

19. The communication system as claimed in claim 14,
comprising at least one wireless access point connected to the at least one communication network, wherein the communication device is a wireless communication device and is configured to detect the entry into the coverage area of the at least one wireless access point and in response thereto to establish a communication connection via the wireless access point to the data management device or to the central management device; or
comprising at least one contact-based device connected to the at least one communication network, wherein the communication device is a contact-based communication device and is configured to detect an electrical connection to the at least one contact-based device and in response thereto to establish a communication connection via the contact-based device to the data management device or to the central management device.

20. The method as claimed in claim 5,
wherein the wireless communication device is mobile and the wireless access point is stationary; or
wherein the wireless communication device is stationary and the wireless access point is mobile.

21. The method as claimed in claim 1, wherein status information is transmitted from the communication device to the data management device, which status information signals that the communication task has been executed completely.

22. The method as claimed in claim 2,
wherein the communication task indicates that there is information which is to be transmitted to the hardware security device of the communication device; and
wherein steps a), b), d), and e) are repeated until all information has been transmitted to the hardware security device of the communication device.

23. The method as claimed in claim 22, wherein the information to be transmitted to the hardware security device of the communication device is stored in encrypted form in the data management device.

24. The method as claimed in claim 22, wherein the information to be transmitted to the hardware security device of the communication device contains security-related data, in particular security updates for a security software stored in the hardware security device.

25. The method as claimed in claim 1,
wherein there are different communication tasks waiting in the data management device;
wherein at least one of the communication tasks may relate to the transmitting of information from the hardware security device of the communication device to the data management device; and
wherein the execution of the different communication tasks is controlled by the data management device in prioritized manner.

26. The method as claimed in claim 1, wherein a communication connection established in step a) can be terminated by the data management device if there is no communication task waiting in the data management device.
